(19) United States
(12) Patent Application Publication
(10) Pub. No.: US 2026/0243611 A1
(43) Pub. Date: Aug. 20, 2026

(54) METHOD AND MEASURING APPARATUS FOR ASCERTAINING A FLUID TEMPERATURE

(71) Applicant: Diehl Metering GmbH, Ansbach (DE)

(72) Inventors: Alexander Hofmann, Sachsen (DE); Steffen Ritter, Bechhofen (DE); Florian Herrmann, Langfurth (DE); Andreas Madinger, Ansbach (DE)

(21) Appl. No.: 19/432,382

(22) Filed: Dec. 24, 2025

(30) Foreign Application Priority Data
Feb. 18, 2025 (DE) 102025106112.2

(51) Int. Cl. G01K 11/24; G01K 13/02

(52) U.S. Cl. CPC G01K 11/24; G01K 13/026

(57) ABSTRACT

A method ascertains a fluid temperature of a fluid that is guided through a measurement volume or located in the measurement volume by a measuring apparatus with a first and a second ultrasonic transducer. An ultrasonic signal is transmitted by the first ultrasonic transducer and transferred to the second ultrasonic transducer by way of the fluid, as a result of which a received signal is detected by way of the second ultrasonic transducer. An oscillation frequency of the received signal is ascertained for a period of time of the received signal. The fluid temperature is ascertained on the basis of the oscillation frequency.

### CROSS-REFERENCE TO RELATED APPLICATION

This application claims the priority, under 35 U.S.C. § 119, of German Patent Application DE 10 2025 106 112.2, filed Feb. 18, 2025; the prior application is herewith incorporated by reference in its entirety.

### FIELD AND BACKGROUND OF THE INVENTION

The invention relates to a method for ascertaining a fluid temperature of a fluid that is guided through a measurement volume or located in the measurement volume by a measuring apparatus with a first and a second ultrasonic transducer. An ultrasonic signal is transmitted by the first ultrasonic transducer and transferred to the second ultrasonic transducer by way of the fluid, as a result of which a received signal is detected by way of the second ultrasonic transducer. In addition, the invention relates to a measuring apparatus and to a line system.

In flow meters, a temperature of the fluid flowing through the flow meter is often ascertained in order to take this temperature into account when ascertaining the flow volume. In addition, temperature detection is required, for example, in order to ascertain a supplied amount of heat in heat meters, for example. A temperature sensor in contact with the fluid, for example a measuring resistor, which is read by a control apparatus of the flow meter, is typically used for temperature detection. However, the use of a temperature sensor results in additional costs and additional effort to implement the flow meter.

It is proposed in U.S. patent publication No. 2022/0146 330 A1 to ascertain the temperature of a fluid flowing through a flow meter from an ascertained speed of sound in the fluid. However, since this results in an ambiguity of the ascertained temperature, the amplitude of the ultrasonic received signal is additionally evaluated in order to eliminate this ambiguity. However, since this amplitude is dependent on a multiplicity of influencing factors and is susceptible to interference, this procedure does not achieve the desired robustness and accuracy of the measurement in some cases.

### SUMMARY OF THE INVENTION

The invention is therefore based on the object of specifying an improved approach for ascertaining a fluid temperature, which is in particular able to be used with little effort in flow meters and achieves a high level of robustness of the temperature ascertainment.

With the foregoing and other objects in view there is provided, in accordance with the invention, a method for ascertaining a fluid temperature of a fluid being guided through a measurement volume or located in the measurement volume by a measuring apparatus with at least a first and a second ultrasonic transducer. The method includes transmitting, via the first ultrasonic transducer, an ultrasonic signal being transferred to the second ultrasonic transducer by way of the fluid, and a received signal is detected by way of the second ultrasonic transducer. An oscillation frequency of the received signal is determined for a period of time of the received signal. The fluid temperature is determined based on the oscillation frequency.

The object is achieved by a method of the type mentioned at the outset, wherein an oscillation frequency of the received signal is ascertained for a period of time of the received signal. The fluid temperature is ascertained on the basis of the oscillation frequency.

The invention makes use of the fact that the frequency of the received signal in ultrasonic measurements, for example in flow measurements according to the propagation time principle, is dependent on the temperature of the fluid transferring the ultrasonic waves. This is especially true for that part of the received signal that results from a ringing of the first ultrasonic transducer following the end of its active excitation. Therefore, in particular, that period of time of the received signal, which is temporally spaced apart from the end of the active excitation of the first ultrasonic transducer by an anticipated propagation time of the ultrasonic signal from the first ultrasonic transducer to the second ultrasonic transducer, and/or in which the amplitude of the received signal drops, may be considered.

Following the end of the active excitation, it may be assumed that the ringing of the respective ultrasonic transducer is dominated by a resonant frequency of the ultrasonic transducer or the measuring system. On account of the respective ultrasonic transducer being coupled to the fluid, the fluid, and in particular the fluid temperature thereof, however, influences the resonant frequency that is actually present and therefore also the frequency of the received signal.

By way of example, the frequency of the received signal in the period of time is able to be ascertained by way of a phase-locked loop or by counting zero crossings or by measuring time intervals between zero crossings of the input signal. In one preferred configuration, however, a frequency analysis of the received signal is carried out. For this purpose, the received signal or an intermediate signal that is obtained from the received signal in particular by way of a frequency conversion and/or filtering and/or amplification may in particular be initially digitized. The digitized signal may then be converted into the frequency domain, for example by means of a fast Fourier transform, after which the oscillation frequency is able to be ascertained in particular by detecting the maximum in the frequency domain representation. A frequency conversion before digitization may be expedient in order to be able to use an analogue-to-digital converter with a relatively low frequency bandwidth.

In tests within the scope of the development of the invention, it was recognized that the relationship between the ascertained oscillation frequency and the fluid temperature is at least approximately linear. By way of example, in the case of a temperature increase of the fluid temperature of a fluid that is guided through the measuring tube of a flow meter of 20° C to 90° C, an at least approximately linear increase of the observed oscillation frequency of the received signal by about 5 kHz was observed. Since a multiplicity of oscillations may typically be observed in the relevant time interval, the fluid temperature of the fluid may therefore be ascertained in principle already on the basis of a received signal of a single ultrasonic measurement. However, since the oscillation frequency ascertained on the basis of a single ultrasonic measurement is typically noticeably noisy, the fluid temperature may be ascertained typically only with relatively low resolution or accuracy without taking into account further measurement variables that will be discussed below.

The accuracy may be improved by averaging a plurality of ascertained oscillation frequencies or fluid temperatures. By way of example, if the temperature is ascertained in the context of a flow measurement, in which, in a manner known per se, a propagation time difference between the propagation time of an ultrasonic signal from the first to the second ultrasonic transducer and the propagation time of a further ultrasonic signal from the second to the first ultrasonic transducer is evaluated, a provisional fluid temperature is therefore able to be ascertained, for example, for each of the measuring directions on the basis of the oscillation frequency of the respective received signal at the respective receiving ultrasonic transducer, and the final fluid temperature is able to be ascertained as an average of the provisional fluid temperatures.

Since, in most applications, it may also be assumed that the temperature of the fluid changes only slowly compared with the required measurement duration for ascertaining the temperature or for ascertaining a flow, the measurement accuracy may be further increased by repeated measurement and subsequent averaging of the fluid temperatures or oscillation frequencies ascertained in this case.

The accuracy of the determination of the fluid temperature may, however, particularly preferably be improved by additionally taking into consideration propagation times of ultrasonic signals between the ultrasonic transducers or a speed of sound, which is ascertained on the basis of these propagation times, in the fluid.

In particular, a first propagation time of the ultrasonic signal from the first ultrasonic transducer to the second ultrasonic transducer and a second propagation time of a further ultrasonic signal from the second ultrasonic transducer to the first ultrasonic transducer may be ascertained. The fluid temperature is ascertained on the additional basis of the first and the second propagation time.

The speed of sound of the ultrasonic signals in the fluid are in particular able to be ascertained on the basis of the first and the second propagation time. If the distance between the ultrasonic transducers along the propagation path of the ultrasonic signals is known, the speed of sound is able to be ascertained approximately as a quotient of double the path length and the sum of the first and the second propagation time. In order to improve the accuracy, propagation time offsets, which may result, for example, owing to the response behavior of the ultrasonic transducers and/or the coupling path between the respective ultrasonic transducer and the fluid and/or the specific configuration of the measuring electronics, maybe taken into consideration. Alternatively, it would be also possible for example, to use a relationship, which is ascertained in the context of a calibration of the measuring apparatus, between the sum of the first and the second propagation time and the speed of sound or the fluid temperature of the fluid.

Although ascertaining the speed of sound or the temperature of the fluid on the basis of the first and the second propagation time allows, as is also explained, for example, in U.S. patent publication No. 2022/0146330 A1 cited at the outset, a good level of ascertainment accuracy, it is ambiguous in and of itself, since for water and water-containing fluid mixtures, for example, the speed of sound initially increases up to a limit temperature and then drops again. For substantially pure water, as is conveyed in water line systems, for example, the maximum speed of sound results at approximately 73° C. The same speed of sound therefore occurs at a temperature below and above this maximum.

Since, however, as already explained above, there is an at least approximately linear or at least monotonic relationship between the oscillation frequency of the received signal and the fluid temperature, a distinction may be made in the method according to the invention on the basis of the ascertained oscillation frequency, which corresponds to the two fluid temperatures, which potentially lead to the ascertained speed of sound, of the fluid temperature actually present.

In particular, a provisional temperature value for the fluid temperature may be initially ascertained on the basis of the oscillation frequency of the received signal, after which:
i) if the provisional temperature value is less than or equal to a first predetermined limit value, a first computation rule is used to compute the fluid temperature from the first and the second propagation time or from a speed of sound, which is ascertained from the first and the second propagation time, in the fluid, and
ii) if the provisional temperature value is greater than or equal to the first or a second predetermined limit value, a second computation rule is used to compute the fluid temperature from the first and the second propagation time or from a speed of sound, which is ascertained from the first and the second propagation time, in the fluid.

As already explained above, the relationship between temperature and speed of sound for some fluids, in particular for water or for water-containing fluids, is not monotonic, and therefore the fluid temperature is not able to be defined over its entire possible value range as functions of speed of sound or the first and the second propagation time. By using the temperature at the maximum of the temperature/speed of sound curve as the first predetermined limit value, however, this curve can be divided into two strictly monotonic partial curves, with the result that a first function may be specified for temperatures below the first predetermined limit value, the function predetermining the fluid temperature on the basis of the speed of sound, and a second function may be specified for temperatures above the first predetermined limit value, the function predetermining the fluid temperature on the basis of the speed of sound.

If a second predetermined limit value is used for the second case, this limit value should in particular be greater than the first predetermined limit value. For provisional temperature values that are between the first and the second predetermined limit value, a third computation rule may in particular be used. The computation rule is able to predetermine the fluid temperature in particular exclusively or additionally on the basis of the oscillation frequency of the received signal.

This may be expedient, since the relationship between temperature and speed of sound in the vicinity of the maximum of the speed of sound has low gradients, which means that even small differences in the speed of sound correspond to relatively large differences in temperature in this temperature range. Therefore, even relatively small errors, such as low noise, when ascertaining the speed of sound or the first and the second propagation time lead to significant temperature errors if only this relationship is taken into consideration. As already explained above, however, the relationship between the oscillation frequency and the fluid temperatures is at least approximately linear for the entire relevant temperature range, with the result that, in the discussed temperature range, it may be expedient to use the provisional temperature value directly as the fluid temperature of the fluid or to compute the fluid temperature as a weighted sum from the provisional temperature value and a further provisional temperature value computed on the basis of the speed of sound. The further provisional temperature value may be ascertained, in particular depending on the value of the provisional temperature value, either by means of the first or by means of the second computation rule.

An AC voltage signal may be applied to the first ultrasonic transducer for generating the respective ultrasonic signal for the duration of an excitation interval in order to excite the first ultrasonic transducer to oscillate, wherein the period of time of the input signal for which the oscillation frequency of the received signal is ascertained begins at a predetermined time interval following the end of the excitation interval. Alternatively or additionally, the period of time of the input signal is able to be selected in such a way that an envelope of the received signal drops at least at the start of the period of time.

As already mentioned at the outset, the fluid temperature of the fluid affected the resonant frequencies of the first and the second ultrasonic transducer or the entire measuring system. Therefore, the oscillation frequencies that occur during free oscillation of the first or the second ultrasonic transducer are particularly relevant to ascertaining the temperature.

The predetermined time interval is in particular greater than or equal to the anticipated propagation time of the ultrasonic signal from the first ultrasonic transducer to the second ultrasonic transducer, with the result that the ultrasonic signal received in the period of time results from free ringing of the first ultrasonic transducer following the end of excitation and/or the received signal results from ringing of the second ultrasonic transducer following the end of the incoming ultrasonic signal. By way of example, the maximum anticipated propagation time may be ascertained in the context of a calibration of the measuring apparatus and/or the expected propagation time may be based on a previous measurement.

The described oscillation state may also be identified additionally or alternatively directly by evaluation of the envelope. An envelope may be ascertained, for example, by squaring and low-pass filtering the received signal or by analyzing a digitized received signal.

The or a first propagation time of the ultrasonic signal from the first ultrasonic transducer to the second ultrasonic transducer and the or a second propagation time of the further or a further ultrasonic signal from the second ultrasonic transducer to the first ultrasonic transducer may be ascertained. A flow volume of the fluid that is guided through the measurement volume may be determined on the basis of the first and the second propagation time, a known geometry of the measurement volume and the fluid temperature, which is ascertained on the basis of the oscillation frequency of the received signal, of the fluid.

It is known in principle that the flow volume ascertained by the known propagation time difference method has a temperature dependency. A dedicated temperature sensor is typically used to take this temperature dependency into consideration, as explained at the outset. However, since the inventive method makes it possible to estimate the fluid temperature in a robust manner even without using a dedicated temperature sensor, it becomes possible to perform a temperature correction even in measuring apparatuses of simple construction without a dedicated fluid temperature sensor.

In order to take into consideration the fluid temperature in the flow determination, a two-dimensional characteristic map may be ascertained in the context of calibrating the measuring apparatus, for example, the characteristic map in each case assigning a flow volume to a multiplicity of pairs of fluid temperature and propagation time difference between the first and the second propagation time. Such a characteristic map may be used directly, for example by way of interpolation, to ascertain the flow volume. However, it may be alternatively expedient to ascertain an analytical relationship between the variables on the basis of the ascertained characteristic map, for example by means of a regression analysis.

The invention also relates to a measuring apparatus with a measurement volume that is limited by an inner wall of the measuring apparatus, a first and a second ultrasonic transducer and a control apparatus. The control apparatus is configured to actuate the first ultrasonic transducer to transmit an ultrasonic signal in a fluid that is guided through the measurement volume or located in the measurement volume and to detect a received signal concerning the ultrasonic signal by way of the second ultrasonic transducer. In this case, the control apparatus is configured to ascertain an oscillation frequency of the received signal for a period of time of the received signal and, on the basis of this oscillation frequency, to ascertain a fluid temperature of the fluid in the measurement volume.

The measuring apparatus may therefore be configured in particular to carry out the method according to the invention. Irrespective of this, the measuring apparatus according to the invention may be further developed using the features mentioned above with respect to the method according to the invention, and vice versa, in order to achieve the advantages mentioned in each case.

The measuring apparatus may be used in particular to ascertain a flow volume through the measurement volume, which, as already explained above with respect to the method according to the invention, may be ascertained or corrected on the basis of the ascertained fluid temperature.

The invention also relates to a line system that comprises a consumer and a heat and/or cold meter, which is configured to ascertain an amount of heat and/or cold supplied to the consumer by means of the line system. The heat and/or cold meter comprises the measuring apparatus and a temperature sensor. The consumer is arranged in the line system between the measuring apparatus and the temperature sensor. The measuring apparatus is configured to ascertain a flow volume of the fluid that is guided through the line system and therefore through the measurement volume. The control apparatus is configured:

on the one hand, to ascertain the amount of heat and/or cold supplied to the consumer on the basis of the ascertained flow volume, a temperature measured value of the temperature sensor and the ascertained fluid temperature of the fluid in the measurement volume, and/or

on the other hand, to ascertain installation information concerning the installation position of the measuring apparatus in the line system on the basis of the ascertained fluid temperature of the fluid in the measurement volume and a respective temperature measured value of the temperature sensor and/or a further temperature sensor of the heat and/or cold meter that is arranged in the line system on the same side of the consumer as the measuring apparatus.

If the measuring apparatus is used as part of a heat and/or cold meter, it may be sufficient for the heat and/or cold meter to have only one temperature sensor, since the temperature difference used in heat meters, in particular multiplied by the flow volume, may be ascertained as the difference between the temperature measured value detected by way of this temperature sensor and the fluid temperature ascertained on the basis of the oscillation frequency of the received signal.

Additionally or alternatively, the fluid temperature may be used to ascertain the installation position or installation information concerning the installation position. It may be expedient to ascertain the installation position, since the flow volume is typically measured in the return line in heat and/or cold meters. If an installation in the feed line is identified, it may be expedient to point this out during start-up and/or to adapt internal operating parameters to operation in the feed line, i.e. to select a different calibration, for example. If, for example, it is known that heat is supplied to the consumer in the current operating state, an installation of the measuring apparatus in the feed line may be identified in particular if the fluid temperature exceeds the temperature measured value.

If two separate temperature sensors are used to ascertain the heat difference, comparing the temperature measured values thereof with the ascertained fluid temperature in the measurement volume in particular therefore makes it possible to identify on the side of which of the temperature sensors the measuring apparatus is arranged with respect to the consumer, and a flow volume is therefore ascertained.

Other features which are considered as characteristic for the invention are set forth in the appended claims.

Although the invention is illustrated and described herein as embodied in a method and a measuring apparatus for ascertaining a fluid temperature, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration of an exemplary embodiment of a line system according to the invention, which contains an exemplary embodiment of the measuring apparatus according to the invention;

FIG. 2 is an illustration of an exemplary received signal of the measuring apparatus shown in FIG. 1;

FIG. 3 is a flowchart of an exemplary embodiment of the method according to the invention for ascertaining a fluid temperature;

FIG. 4 is a graph showing a scatter diagram of the oscillation frequencies of a received signal of an ultrasonic transducer that are observed at different fluid temperatures of the fluid; and

FIG. 5 is a graph showing the relationship between fluid temperature and speed of sound in water.

### DETAILED DESCRIPTION OF THE INVENTION

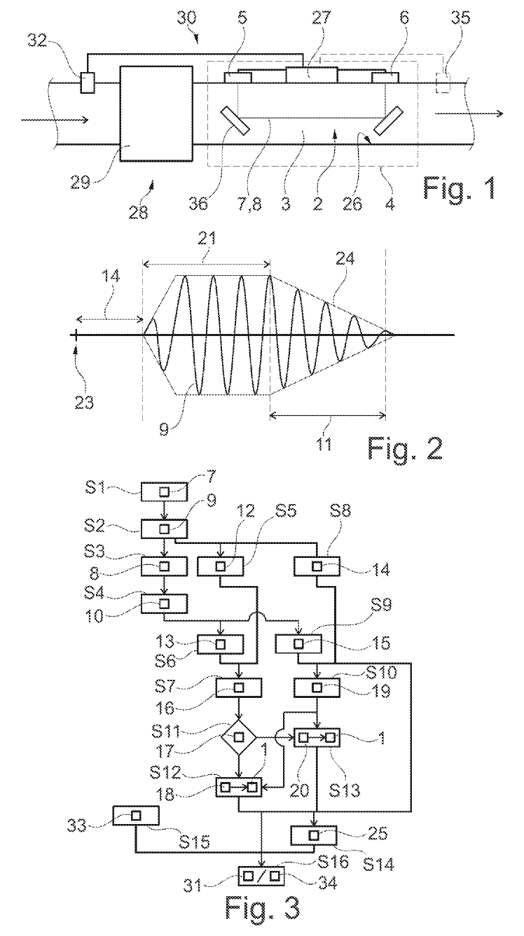

Referring now to the figures of the drawings in detail and first, particularly to FIG. 1 thereof, there is shown a section of a line system 28 for supplying heat and/or cold to a consumer 29. In the following explanations, a supply of heat is usually assumed by way of example. For this purpose, a fluid 3, for example water, is supplied from the left in the image to the line system 28 at a temperature that is above the temperature of the consumer 29. When flowing through the consumer 29, heat from the fluid 3 is therefore transferred to the consumer 29, such that when it reaches the right image region or a measuring apparatus 4, the temperature of the fluid 3 is lowered relative to the inflow. In the same way, the consumer 29 may also be supplied with cold if the fluid 3 is supplied with a temperature below the consumer temperature.

It is often desired to record the amount of heat or cold supplied to the consumer 29, for example for billing purposes. In conventional heat and/or cold meters, two temperature sensors 32, 35 on different sides of the consumer 29 are typically used for this purpose to detect a temperature change in the fluid 3 as it flows through the consumer 29. The supplied heat or cold is able to be quantified by multiplying the temperature difference by a flow volume detected by means of the measuring apparatus 4.

However, as will be explained in more detail below, a control apparatus 27 of the measuring apparatus 4 is configured to ascertain the fluid temperature 1 in a measurement volume 2, which is limited by an inner wall 26 of the measuring apparatus 4, on the basis of received signals 9, 10 of the ultrasonic transducers 5, 6 of the measuring apparatus 4 that are detected in any case for ascertaining a flow volume 25, with the result that the temperature sensor 35 may be dispensed with, and the design of the heat and/or cold meter 30 is able to be simplified.

This configuration is explained in the following in the context of the heat and/or cold meter 30 shown in FIG. 1. However, such a configuration of the measuring apparatus 4 may also be expedient if the measuring apparatus 4 is used as a pure volumetric flow meter, for example, without a heat balance being detected. Flow measurements on the basis of ultrasonic signals may specifically have a clear temperature dependency, and it is therefore advantageous to detect and to take into consideration the fluid temperature 1 of the fluid 3 in the measurement volume 2 in order to achieve a high measurement accuracy. Since the control apparatus 27 enables such a temperature ascertainment even without a dedicated temperature sensor 35, a simpler and therefore smaller and more favorable design of the measuring apparatus 4 may also be used in this case.

The principle of the temperature ascertainment used by the control apparatus 27 is explained below with additional reference to FIG. 2, which schematically shows a received signal 9 of the ultrasonic transducer 6 that results from an operation of the ultrasonic transducer 5 for transmitting the ultrasonic signal 7.

The ultrasonic signal 7 transmitted by the ultrasonic transducer 5 propagates through the fluid 3 in the measurement volume 2, wherein it is deflected twice by the ultrasonic mirrors 36 and therefore supplied to the ultrasonic transducer 6. It is therefore received after a propagation time 14 of the ultrasonic signal 7 after the start 23 of the excitation by the receiving ultrasonic transducer 5, 6. An envelope 24 of the received signal 9 increases initially for a short time due to a transient delay of the ultrasonic transducers 5, 6, after which the amplitude initially remains constant due to the constant excitation amplitude of the ultrasonic transducer 5. Following the end of the active excitation, the transmitting ultrasonic transducer 5 is still ringing, with the result that an ultrasonic signal 7 continues to be transferred for a certain amount of time with decreasing amplitude. For this reason and due to the ringing of the receiving ultrasonic transducer 6, a falling amplitude or envelope 24 of the received signal 9 results in the period of time 11.

The received signal 9 in the period of time 11 therefore results from an oscillation of the ultrasonic transducers 5, 6, while these are not actively excited with a control signal of the control apparatus 27. The oscillation frequency 12 of the received signal in the period of time 11 therefore corresponds to a resonant frequency of the system of the ultrasonic transducers 5, 6 and the fluid 3 used for ultrasonic transfer and is therefore dependent on properties of the fluid 3 and specifically on the fluid temperature thereof.

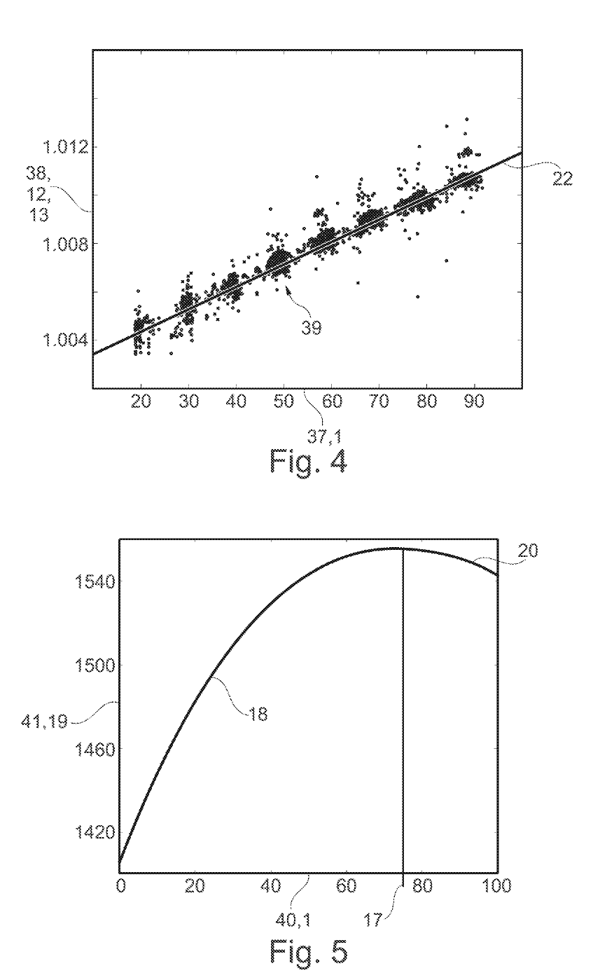

It was recognized that the relationship 22 between the fluid temperature 1 and the oscillation frequency 12 is at least approximately linear. This can be seen, for example, in the scatter diagram shown in FIG. 4, which shows, on the y-axis 38, the respective oscillation frequency 12, 13 of the respective received signal 9, 10 in MHz for a plurality of measurements 39 during a step-wise increase and decrease of the fluid temperature 1 shown on the x-axis 37 in °C. The measurements 39 were taken partly for a signal propagation in the flow direction and partly for a signal propagation counter to the flow direction. In particular on account of the step-like increase in the fluid temperature 1 and the resulting temperature inhomogeneity, which occurs in portions of the measurements 39, in the fluid 3, the shown measurements 39 are scattered relatively strongly. However, the linear relationship 22 between the fluid temperature 1 and the oscillation frequency 12 is clearly recognizable and quantifiable on the basis of the measurements shown.

If the propagation time 14 of the ultrasonic signal 7 is known or is measured, then the start of the period of time 11 may be selected such that it is delayed with respect to the start of the excitation of the ultrasonic transducer 7 by the sum of the duration 21 of the excitation interval, during which an AC voltage signal is applied to the ultrasonic transducer 5, and the propagation time 14. Alternatively, it would also be possible to select the period of time on the basis of the envelope 24 of the received signal 9 in such a way that the envelope 24 drops during the period of time 11. As a result of the two approaches, it may be achieved that, in the period of time 11, the received signal 9 results from free ringing of the ultrasonic transducers 5, 6 without excitation by the control apparatus 27, whereby the oscillation frequency 12, as already explained above, may be linearly related to the fluid temperature 1 and the fluid temperature 1 may therefore be ascertained from this oscillation frequency 12.

As has already been explained in the general part, a temperature ascertainment that is based exclusively on the oscillation frequency 12 may be susceptible to errors or inaccurate. An approach for more robust and more accurate ascertainment of the fluid temperature 1 as well as expedient steps for further processing the fluid temperature 1 are explained below with reference to the flowchart shown in FIG. 3.

Here, in step S1, the ultrasonic transducer 5 is initially actuated by the control apparatus 27 in order to transmit the ultrasonic signal 7 into the fluid 3. The ultrasonic signal 7 is deflected a plurality of times by the ultrasonic mirrors 36 to guide it to the ultrasonic transducer 6. By way of the ultrasonic transducer, the control apparatus 27 then detects a received signal 9 concerning the ultrasonic signal 7 in step S2.

In order to be able to detect the ascertainment of a speed of sound 19 in the fluid 3 in a robust manner even when the fluid 3 is flowing through the measurement volume 2, and to enable a flow volume to be ascertained, the measurement process explained above is repeated in the opposite direction in the example. For this purpose, in step S3, the ultrasonic transducer 6 is actuated by the control apparatus 27 in order to transmit the ultrasonic signal 8 into the fluid 3. The ultrasonic signal 8 is guided to the ultrasonic transducer 5 by way of the ultrasonic mirrors 36 in order, in step S4, to detect a received signal 10 concerning the ultrasonic signal 8.

In step S5, as already explained above, a period of time 11 of the received signal 9, in which the received signal is shaped by ringing of the ultrasonic transducers 5, 6 and therefore by a natural frequency of the measuring system, is then selected, and the oscillation frequency 12 of the received signal 9 in this period of time 11 is ascertained. For this purpose, the received signal 9 or the period of time 11 may be Fourier-transformed, for example following digitization, in order to find the dominant frequency, or the oscillation frequency 12 may be ascertained, for example on the basis of ascertained time intervals between zero crossings of the received signal 9.

In principle, it would be possible to ascertain the fluid temperature in the measurement volume 2 directly on the basis of this oscillation frequency 12 and the linear relationship 22, which has already been explained with reference to FIG. 4, between this oscillation frequency 12 and the fluid temperature 1. However, since the received signal 10 is already present in the described method, the signal is also used in the example to improve the accuracy of the estimation. For this purpose, in step S6, in particular in the manner already described in relation to step S5, a period of time of the received signal 10, in which the received signal is shaped by ringing of the ultrasonic transducers 5, 6 and therefore by a natural frequency of the measuring system, is selected, and the oscillation frequency 13 of the received signal 10 in this period of time is ascertained.

A provisional temperature value 16 for the fluid temperature 1 may then be ascertained in step S7 on the basis of the relationship 22, which is shown in FIG. 4, between the respective oscillation frequency 12, 13 and the fluid temperature 1. Due to the linearity of this relationship 22, it is optionally either possible to ascertain the provisional temperature value 16 in the example on the basis of the average of the oscillation frequencies 12, 13 or it is possible to form an average between separately ascertained provisional temperature values for the two oscillation frequencies 12, 13.

The temperature value 16 is initially only used as a provisional temperature value 16 for the fluid temperature 1 in the method configuration shown, since, as is explained below, the robustness and accuracy of the ascertainment may be further improved by additionally ascertaining and taking into consideration the speed of sound 19 in the fluid 3.

For this purpose, in step S8, a first propagation time 14 of the ultrasonic signal 7 from the first ultrasonic transducer 5 to the second ultrasonic transducer 6 is initially ascertained. Since the temporal position of the received signal 9 with respect to the start 23 of the excitation of the ultrasonic transducer 5 is known, for this purpose it is possible to ascertain, for example, the time of the received signal 9 at which the received signal or the envelope 24 thereof exceeds a limit value. Accordingly, in step S9, a second propagation time 15 of the ultrasonic signal 8 from the second ultrasonic transducer 6 to the first ultrasonic transducer 5 is ascertained.

Since the length of the propagation path of the ultrasonic signals 7, 8 is known on account of the known measurement geometry, the speed of sound 19 in the fluid may then be ascertained as a quotient of the distance and the sum of the propagation times 14, 15 in step S10. Optionally, an offset may be applied to the sum before forming the quotient, for example to take into consideration known delays in the actuation or acquisition of measured values.

In the example shown, it is assumed that the fluid 3 guided through the measurement volume 2 is known. For known fluids, the level of the speed of sound 19 in the respective fluid 3 at different fluid temperatures 1 is able to be determined from tables or by way of preliminary measurements. This relationship is shown in FIG. 5 by way of example for water, wherein fluid temperature 1 is plotted on the x-axis 40 in ° C and the speed of sound 19 is plotted on the y-axis 41 in m/s. For some fluids, for example for water and water-containing liquids 3, the speed of sound 19 initially increases with increasing fluid temperature 1, but drops again after reaching a maximum speed of sound, which is at approximately 73° C in FIG. 5. It is therefore not possible in the example to clearly assign a fluid temperature 1 to the speed of sound 19 ascertained in step S10 on the basis of the relationship shown in FIG. 5 alone.

Therefore, in step S11, a check is carried out to determine whether the provisional temperature value 16 ascertained in step S7 on the basis of the oscillation frequencies 12, 13 is less than or equal to a predetermined limit value 17, which in the example coincides with the maximum of the speed of sound in FIG. 5. If this is the case, a first computation rule 18, which corresponds to the section of the relationship shown to the left of the limit value 17 in FIG. 5, is therefore used in step S12 in order to compute the fluid temperature 1 from the speed of sound 19 in the fluid 3. Otherwise, a second computation rule 20, which corresponds to the section of the relationship shown to the right of the limit value 17 in FIG. 5, is used in step S13 in order to compute the fluid temperature 1 from the speed of sound 19 in the fluid 3.

In the example, the relationship shown in FIG. 4 between the fluid temperature 1 and the oscillation frequencies 12, 13 is therefore used to eliminate the ambiguity of the relationship shown in FIG. 5 between the fluid temperature and the speed of sound 19.

In step S14, a flow volume 25 of the fluid 3 that is guided through the measurement volume 2 is then determined on the basis of the first and the second propagation time 14, 15, a known geometry of the measurement volume 2 and the fluid temperature 1. By way of example, a two-dimensional look-up table or a corresponding analytical relationship, which already takes into consideration the geometry of the measurement volume 2, may be used to assign pairs of a respective propagation time difference between the first and the second propagation time 14, 15 and a respective fluid temperature to a respective flow volume.

As has already been explained, the measuring apparatus 4 is used as part of a heat and/or cold meter 30 in the example shown in FIG. 1.

Therefore, in step S15, a temperature measured value 33 for the temperature of the fluid before flowing through the consumer 28 is ascertained by the control apparatus by means of the temperature sensor 32 arranged in the feed line of the consumer 29. In order to ascertain the amount of heat and/or cold supplied 31, the ascertained flow volume 25 may then be multiplied by a temperature difference between the temperature measured value 33 and the fluid temperature 1, which is ascertained in step S12 or S13, of the fluid 3 in the measurement volume 2.

If, for the current operating state of the heat and/or cold meter 30, it is known whether heat or cold is currently being supplied to the consumer 29, installation information 34 may also be ascertained by comparing the temperature measured value 33 with the ascertained fluid temperature 1 of the fluid 3 in the measurement volume 2, the information indicating whether the measuring apparatus 4 ascertaining the flow volume 25 is arranged in the feed line or in the return line of the consumer 29. For example, internal parameters of the heat and/or cold meter 30, for example calibration variables, are able to be adapted on the basis of this installation information 34.

The following is a summary list of reference numerals and the corresponding structure used in the above description of the invention:

1 Fluid temperature

2 Measurement volume

3 Fluid

4 Measuring apparatus

5, 6 Ultrasonic transducer

7, 8 Ultrasonic signal

9, 10 Received signal

11 Period of time

12, 13 Oscillation frequency

14, 15 Propagation time

16 Temperature value

17 Limit value

18 Computation rule

19 Speed of sound

20 Computation rule

21 Duration

22 Relationship

23 Start

24 Envelope

25 Flow volume

26 Inner wall

27 Control apparatus

28 Line system

29 Consumer

30 Cold meter

31 Amount of cold

32 Temperature sensor

33 Temperature measured value

34 Installation information

35 Temperature sensor

36 Ultrasonic mirror

37 x-axis

38 y-axis

39 Measurement

40 x-axis

41 y-axis

S1-S16 Step

1. A method for ascertaining a fluid temperature of a fluid being guided through a measurement volume or located in the measurement volume by a measuring apparatus with at least a first and a second ultrasonic transducer, which comprises the steps of:
transmitting, via the first ultrasonic transducer, an ultrasonic signal being transferred to the second ultrasonic transducer by way of the fluid, and a received signal is detected by way of the second ultrasonic transducer;
determining an oscillation frequency of the received signal for a period of time of the received signal; and
determining the fluid temperature based on the oscillation frequency.

2. The method according to claim 1, which further comprises:
determining a first propagation time of the ultrasonic signal from the first ultrasonic transducer to the second ultrasonic transducer;
determining a second propagation time of a further ultrasonic signal from the second ultrasonic transducer to the first ultrasonic transducer; and
determining the fluid temperature on an additional basis of the first and the second propagation times.

3. The method according to claim 2, which further comprises:
initially determining a provisional temperature value for the fluid temperature on a basis of the oscillation frequency of the received signal, after which:
if the provisional temperature value is less than or equal to a first predetermined limit value, a first computation rule is used to compute the fluid temperature from the first and the second propagation times or from a speed of sound, the speed of sound being ascertained from the first and the second propagation times, in the fluid; and
if the provisional temperature value is greater than or equal to the first predetermined limit value or a second predetermined limit value, a second computation rule is used to compute the fluid temperature from the first and the second propagation times or from the speed of sound, which is ascertained from the first and the second propagation times, in the fluid.

4. The method according to claim 1, which further comprises:
applying an AC voltage signal to the first ultrasonic transducer for generating the ultrasonic signal for a duration of an excitation interval in order to excite the first ultrasonic transducer to oscillate, wherein the period of time of an input signal for which the oscillation frequency of the received signal is ascertained begins at a predetermined time interval following an end of the excitation interval; and/or
selecting the period of time of the input signal such that an envelope of the received signal drops at least at a start of the period of time.

5. The method according to claim 1, which further comprises:
determining a first propagation time of the ultrasonic signal from the first ultrasonic transducer to the second ultrasonic transducer;
determining a second propagation time of a further ultrasonic signal from the second ultrasonic transducer to the first ultrasonic transducer; and
determining a flow volume of the fluid being guided through the measurement volume on a basis of the first and the second propagation times, a known geometry of the measurement volume and the fluid temperature, the fluid temperature being ascertained on a basis of the oscillation frequency of the received signal.

6. A measuring apparatus, comprising:
an inner wall defining a measurement volume of the measuring apparatus;
a first and a second ultrasonic transducer; and
a controller configured to actuate said first ultrasonic transducer to transmit an ultrasonic signal in a fluid that is guided through said measurement volume or disposed in said measurement volume and to detect a received signal concerning the ultrasonic signal by way of said second ultrasonic transducer, said controller configured to ascertain an oscillation frequency of the received signal for a period of time of the received signal and, on a basis of the oscillation frequency, said controller determines a fluid temperature of the fluid in said measurement volume.

7. A line system, comprising:
said measuring apparatus according to claim 6;
a consumer; and
a heat and/or cold meter configured to ascertain an amount of heat and/or cold supplied to said consumer by means of the line system, wherein said heat and/or cold meter having said measuring apparatus and a temperature sensor, wherein said consumer is disposed in the line system between said measuring apparatus and said temperature sensor, wherein said measuring apparatus is configured to ascertain a flow volume of the fluid that is guided through the line system and therefore through said measurement volume, wherein said controller is configured to:
determine an amount of heat and/or cold supplied to said consumer on a basis of the flow volume, a temperature measured value of said temperature sensor and the fluid temperature of the fluid in said measurement volume; and/or
determine installation information concerning an installation position of said measuring apparatus in the line system on a basis of the fluid temperature of the fluid in said measurement volume and the temperature measured value of said temperature sensor and/or of a further temperature sensor of said heat and/or cold meter that is disposed in the line system on a same side of said consumer as said measuring apparatus.
